(19) United States
(12) Patent Application Publication
(10) Pub. No.: US 2006/0002036 A1
(43) Pub. Date: Jan. 5, 2006

(54) Magnetoresistance effect film and magnetoresistance effect head

(75) Inventor: Hidehiko Suzuki, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/998,281

(22) Filed: Nov. 23, 2004

(30) Foreign Application Priority Data
Jul. 2, 2004 (JP) 2004-196238

(51) Int. Cl. G11B 5/33; G11B 5/127

(52) U.S. Cl. 360/324.1

(57) ABSTRACT

The magnetoresistance effect film of the present invention is more reliable than conventional magnetoresistance effect films. The magnetoresistance effect film has a layered structure, in which a seed layer, a magnetic oxide layer, a pinned magnetic layer, a nonmagnetic intermediate layer, and a free magnetic layer are layered in this order. The seed layer is made of a metallic oxide, and the magnetic oxide layer is made of CoₓFe₃₋ₓO_{y} (x=1.10-1.71, y≠0).

### BACKGROUND OF THE INVENTION

The present invention relates to a magnetoresistance effect film, which has high magnetic resistance ratio (MR ratio) and a magnetoresistance effect head including said magnetoresistance effect film.

Surface recording density of hard disks are increasing higher and higher. By increasing the surface recording density, a required area of a hard disk for each bit can be smaller, so that a high sensitive reproducing head is required in a hard disk drive unit.

A basic structure of a conventional magnetoresistance effect film is shown in FIG. 6. An antiferromagnetic layer 11, a pinned magnetic layer 4, a nonmagnetic intermediate layer 5, a free magnetic layer 6 and a protection layer 7 are piled therein. Even if a magnetic field is applied to the pinned magnetic layer 4 from a recording medium, a magnetizing direction of the pinned magnetic layer 4 must be fixed. To fix the magnetizing direction, the antiferromagnetic layer 11, which is made of an antiferromagnetic material, e.g., platinum-manganese (PtMn), is provided to contact the pinned magnetic layer 4. With this structure, the layers 4 and 11 are coupled by an exchange coupling magnetic field therebetween, so that the magnetizing direction of the pinned magnetic layer 4 can be fixed.

A magnetoresestance effect is caused by electrons running boundary surfaces of the layers 4, 5 and 6. However, since the antiferromagnetic layer 11 is usually made of an alloy, an electric current runs in the layer 11. The current is called a shunt current, which lowers the MR ratio. A specific resistance of the alloy of the antiferromagnetic layer 11 is greater than those of other layers 4, 6, etc., but thickness of the layer 11 with respect to total thickness of the magnetoresistance effect film is great, e.g., about 40%, so that the shunt current running through the layer 11 cannot be ignored.

Using an insulating material instead of the antiferromagnetic layer 11 is disclosed in two documents: (1) M. J. Carey, S. Maat, R. Farrow, R. Marks, P. Nguyen, P. Rice, A Kellock and B. A. Gurney, Digest Intermag Europe 2002, BP2; and (2) S. Maat, M. J. Carey, Eric E. Fullerton, T. X. Le, P. M. Rice and B. A. Gurney, Appl. Phys. Lett. 81, 520 (2002). In the two documents, cobalt-ferrite (CoFe₂O₄) is used instead of the antiferromagnetic layer 11 of the conventional magnetoresistance effect film. The cobalt-ferrite is an insulating material and a ferri magnetic material having a great coercive force. Therefore, the magnetizing direction of the pinned magnetic layer 4 can be fixed with reducing the shunt current.

An example of a ρ-H (resistivity-external magnetic field dependency) characteristic of a magnetoresistance effect film, which has the ferri magnetic material, e.g., cobalt-ferrite, is shown in FIG. 7. A value of a coupling magnetic field Hc(pin) defined in FIG. 7, which is a magnetic field when amount of varying sheet resistance is ½) depends on that of an exchange coupling magnetic field between the oxide magnetic layer (a ferromagnetic material) and the pinned magnetic layer. When temperature rises, the value Hc(pin) decreases. Temperature of an element of an operating magnetic head is about 100° C., but the temperature further instantaneously rises when static electricity is instantaneously applied to the element. This phenomenon is called “electrostatic discharge (ESD)”. The ESD badly influences the element. For example, when the Hc(pin) value is decreased by the ESD, external magnetic fields (e.g., a magnetic field generated by a sensing current, a magnetic field generated by a recording medium) are applied in the opposite direction with respect to a magnetizing direction of the pinned magnetic layer so that the magnetizing direction of the pinned magnetic layer is reversed. To prevent the reversal of the magnetizing direction of the pinned magnetic layer, the Hc(pin) value must be great. Therefore, a magnetoresistance effect film having not only great MR ratio but also great Hc(pin) value must be required so as to realize highly reliable high density magnetic recording.

### SUMMARY OF THE INVENTION

An object of the present invention is to provide a highly relicable magnetoresistance effect film, in which a magnetic oxide layer is used to fix a magnetizing direction of a pinned magnetic layer.

Another object is to provide a magnetoresistance effect head employing the magnetoresistance effect film.

To achieve the objects, the present invention has following structures.

Namely, the magnetoresistance effect film of the present invention has a layered structure, in which a seed layer, a magnetic oxide layer, a pinned magnetic layer, a nonmagnetic intermediate layer, and a free magnetic layer are layered in this order, wherein the seed layer is made of a metallic oxide, and the magnetic oxide layer is made of CoₓFe₃₋ₓO_{y} (x=10-1.71, y≠0).

In the magnetoresistance effect film, the seed layer may be made of a metallic oxide, in which at least one of lattice constant is within a range of 0.406-0.432 nm, or a solid solution of a plurality of metallic oxides having the lattice constant, or a solid solution of at least one of the metallic oxides and an oxide whose lattice constant is deviated from the range of 0.406-0.432 nm. And, the metallic oxide may be selected from a group including sodium dioxide (NaO₂), magnesium monoxide (MgO), potassium trioxide (KO₃), titanium monoxide (TiO), vanadium monoxide (VO), iron monoxide (FeO), cobalt monoxide (CoO), nickel monoxide (α-NiO), copper monoxide (Cu₂O), rubidium dioxide (Rb₂O₂), niobium monoxide (NbO), cesium monoxide (Cs₂O) and cesium dioxide (Cs₂O₂).

In the magnetoresistance effect film, the seed layer may be made of a metallic oxide, in which at least one of lattice constant is within a range of 0.813-0.863 nm, or a solid solution of a plurality of metallic oxides having the lattice constant, or a solid solution of at least one of the metallic oxides and an oxide whose lattice constant is deviated from the range of 0.813-0.863 nm. And, the metallic oxide may be selected from a group including chromium trioxide (CrO₃), iron trioxide (γ-Fe₂O₃) and iron tetroxide (Fe₃O₄).

In the magnetoresistance effect film, the pinned magnetic layer may include a first pinned magnetic layer, an intermediate coupling layer, and a second pinned layer, and the first pinned magnetic layer and the second pinned magnetic layer may be coupled in anti-parallel by an exchange coupling magnetic field.

In the magnetoresistance effect film, the intermediate coupling layer may be made of selected from a group including ruthenium (Ru), iridium (Ir), rhodium (Rh) and chromium (Cr), or an alloy including at least one selected from the group.

Further, the magnetoresistance effect head of the present invention includes a magnetoresistance effect film, which has a layered structure, in which a seed layer, a magnetic oxide layer, a pinned magnetic layer, a nonmagnetic intermediate layer, and a free magnetic layer are layered in this order, wherein the seed layer is made of a metallic oxide, and the magnetic oxide layer is made of CoₓFe₃₋ₓO_{y} (x=1.10-1.71, y≠0). This magnetoresistance effect head has high reliability.

In the magnetoresistance effect head, the seed layer may be used as the whole or a part of an insulating gap layer. This magnetoresistance effect head has high resolution. And, in the magnetoresistance effect head, the metallic oxide of the seed layer may be nonmagnetic at temperature of 300° K.

In the present invention, the magnetoresistance effect film has the layered structure, in which the seed layer, the magnetic oxide layer, the pinned magnetic layer, the nonmagnetic intermediate layer, and the free magnetic layer are layered in this order. A value of a coupling magnetic field Hc(pin) of the magnetoresistance effect film is greater than that of the conventional film whose magnetic oxide layer is made of cobalt-ferrite (CoFe₂O₄). Therefore, reliability of the magnetoresistance effect film and the magnetoresistance effect head of the present invention can be improved.

### BRIEF DESCRIPTION OF THE DRAWINGS

Embodiments of the present invention will now be described by way of examples and with reference to the accompanying drawings, in which:

FIG. 1 is an explanation view of a magnetoresistance effect film of an embodiment of the present invention;

FIG. 2 is an explanation view of a magnetoresistance effect head;

FIG. 3 is an explanation view of a magnetoresistance effect film having a layered ferri structure;

FIG. 4 is an explanation view of a magnetoresistance effect film having a dual structure;

FIG. 5 is a plan view of a magnetic disk drive unit having a magnetoresistance effect head;

FIG. 6 is an explanation view of the conventional magnetoresistance effect film; and

FIG. 7 is a graph showing resistivity-external magnetic field dependency of the conventional magnetoresistance effect film, which has the ferri magnetic material, and defining the value Hc(pin).

### DETAILED DESCRIPTION OF THE EMBODIMENTS

Preferred embodiments of the present invention will now be described in detail with reference to the accompanying drawings.

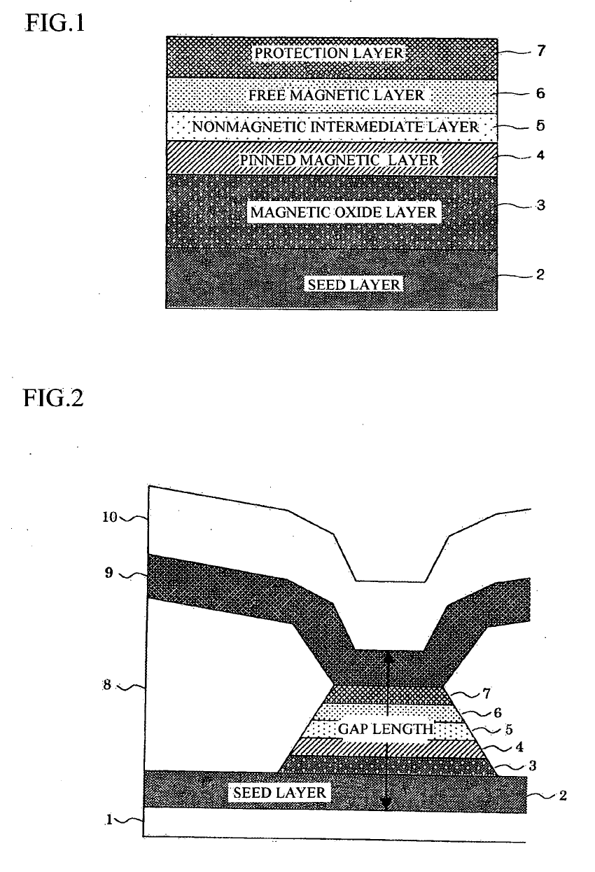

A basic structure of the magnetoresistance effect film of the present embodiment is shown in FIG. 1. In the magnetoresistance effect film, a seed layer 2, which controls orientation of a magnetic oxide layer 3, is provided under the magnetic oxide layer 3. Further, a pinned magnetic layer 4, a nonmagnetic intermediate layer 5, a free magnetic layer 6 and a protection layer 7 are layered on the magnetic oxide layer 3 in this order. The seed layer 2 is made of a metallic oxide, e.g., MgO; the magnetic oxide layer 3 is made of a magnetic oxide whose film composition is indicated as CoₓFe₃₋ₓO_{y}.

The inventors performed an experiment.

Samples of magnetoresistance effect films were formed on silicon substrates by a magnetron spattering method. A structure of the samples was as follows:
(CoO_Co₃O₄) 10/CoxFe₃₋ₓO_{y} 10/CoFe/Cu/CoFe/NiFe/Cu/Ta [nm]

In the layered structure, the (CoO_Co₃O₄) layer was a solid solution of CoO and Co₃O₄, and it corresponded to the seed layer 2 shown in FIG. 1, which is made of the metallic oxide; the CoₓFe₃₋ₓO_{y} layer corresponded to the magnetic oxide layer 3; the CoFe layer corresponded to the pinned magnetic layer 4; the Cu layer corresponded to the nonmagnetic intermediate layer 5; the CoFe/NiFe layer corresponded to the free magnetic layer 6; and the Cu/Ta layer corresponded to the protection layer 7.

The layers corresponding to the magnetic oxide layer 3 were formed by simultaneous electric discharge with CoFe₂O₄ targets and CoO targets. The CoₓFe₃-ₓO_{y} layers having different compositions of Co were formed by adjusting power of discharging electricity toward the targets.

Magnetic characteristics of the samples having different compositions of Co are shown in TABLE. Note that, ρ/t stands for sheet resistance.

TABLE

| | | | | |
|---|---|---|---|---|
| Composition x | M/R Ratio | Δ ρ/t [Ω] | ρ/t [Ω] | Hc(pin) [kA/m] |

| | | | | |
|---|---|---|---|---|
| 1.00 | 14.72 | 5.17 | 35.1 | 203 |
| 1.10 | 14.40 | 5.22 | 36.2 | 225 |
| 1.16 | 14.60 | 5.21 | 35.7 | 310 |
| 1.21 | 15.20 | 5.56 | 36.6 | 329 |
| 1.26 | 14.52 | 5.22 | 35.9 | 320 |
| 1.68 | 14.15 | 5.21 | 36.8 | 224 |
| 1.71 | 14.08 | 5.23 | 37.2 | 220 |

In the TABLE, the composition x=1.00 means that the magnetic oxide layer 3 was made of cobalt-ferrite (CoFe₂O₄) and corresponded to the magnetoresistance effect films disclosed in the documents (1) and (2). In the case of x=1.00, the M/R ratio was 14.72% and the Hc(pin) value was 203 [kA/m]; in cases of x=1.10-1.71, the M/R ratios were almost the same as that of the case x=1.00, but the Hc(pin) values increased to 220-329 [kA/m]. Especially, in a range of x=1.16-1.26, the effect was remarkable. Therefore, by suitably controlling the composition of the magnetic oxide layer 3 or the value of “x” of the CoxFe₃₋ₓO_{y} layer, the magnetoresistance effect film having a great Hc(pin) value can be produced without decreasing the M/R ratio. By increasing the M/R ratio and the Hc(pin) value of the magnetoresistance effect film, sensitivity of the magnetoresistance effect film can be improved, and reliability of a magnetoresistance effect head having the magnetoresistance effect film can be improved.

A metallic oxide, which is capable of lattice-matching with the magnetic oxide layer 3 and which generates no shunt current, may be used as the seed layer 2, which acts as a base layer of the magnetic oxide layer 3. In the case of the magnetic oxide layer 3 made of cobalt-ferrite whose x=1.00, the cobalt-ferrite is a cubic system material constituted four sub-lattices, and its lattice constant is 0.838 nm. Therefore, it lattice-matches with materials whose lattice constants are around 0.419 m or 0.838 nm.

Composition of the seed layer 2 is similar to that of the cobalt-ferrite of the magnetic oxide layer 3. If lattice mismatch rate is 3% or less, there is possibility of lattice-matching. Therefore, the seed layer 2 having the lattice constants for lattice match 0.406-0.432 nm and 0.813-0.863 nm can be used.

Metallic oxides having the lattice constant of 0.406-0.432 nm are sodium dioxide (NaO₂), magnesium monoxide (MgO), potassium trioxide (KO₃), titanium monoxide (TiO), vanadium monoxide (VO), iron monoxide (FeO), cobalt monoxide (CoO), nickel monoxide (α-NiO), copper monoxide (Cu₂O), rubidium dioxide (Rb₂O₂), niobium monoxide (NbO), cesium monoxide (Cs₂O) and cesium dioxide (Cs₂O₂). And, metallic oxides having the lattice constant of 0.813-0.863 nm are chromium trioxide (CrO₃), iron trioxide (γ-Fe₂O₃) and iron tetroxide (Fe₃O₄). The metallic oxides are selectively used as the material of the seed layer 2. Further, a solid solution of said metallic oxides may be used as the material of the seed layer 2.

In the experiment whose results are shown in the TABLE, a solid solution of CoO and Co₃O₄ was used as the seed layer 2. Further, a solid solution of a metallic oxide having the lattice constant of 0.406-0.432 nm, e.g., cobalt monoxide (CoO), and another oxide having different lattice constant, e.g., Co₃O₄, may be used. In this case, one or a plurality of the above described oxides may be used as the metallic oxide.

In the magnetoresistance effect film of the present invention, the seed layer 2 is made of the metallic oxide, so the seed layer 2 may act as an insulating gap layer of a magnetoresistance effect head. An example of the magnetoresistance effect head is shown in FIG. 2. FIG. 2 shows a read section of the magnetoresistance effect head. The seed layer 2, which acts as a lower insulating gap layer, is formed on a lower magnetic shielding layer 1. Further, the magnetic oxide layer 3, the pinned magnetic layer 4, the nonmagnetic intermediate layer 5, the free magnetic layer 6 and the protection layer 7 are layered on the seed layer 2 in this order. Both side faces of the magnetoresistance effect film are etched, so that they are formed into slope faces. Magnetic biasing layers and electrodes 8 are respectively formed on the both sides of the magnetoresistance effect film. An upper insulating gap layer 9 electrically insulates an upper magnetic shielding layer 10 from the electrodes 8 and the magnetoresistance effect film.

Alumina is usually used for the insulating gap layers. In FIG. 2, the seed layer 2 made of the metallic oxide acts as the lower insulating gap layer, so that a gap length, which is a distance between the lower shielding layer 1 and the upper shielding layer 10, can be shortened. By shortening the gap length, resolution of a reproducing magnetic head can be improved, so that magnetic recording density of a hard disc can be increased.

In FIG. 2, the lower insulating gap layer is wholly replaced with the seed layer 2 made of the metallic oxide. Further, a plurality of lower insulating gap layers may be formed, and the uppermost layer may act as the seed layer 2 made of the metallic oxide.

In FIG. 2, the seed layer 2 directly contacts the lower magnetic shielding layer 1. The lower magnetic shielding layer 1 has soft magnetism and shields an external magnetic field. However, if the seed layer 2 has magnetism, the lower magnetic shielding layer 1 and the seed layer 2 are exchange-coupled, so that magnetic shielding characteristics are badly influenced. Therefore, preferably the seed layer 2 in FIG. 2 is nonmagnetizable at room temperature.

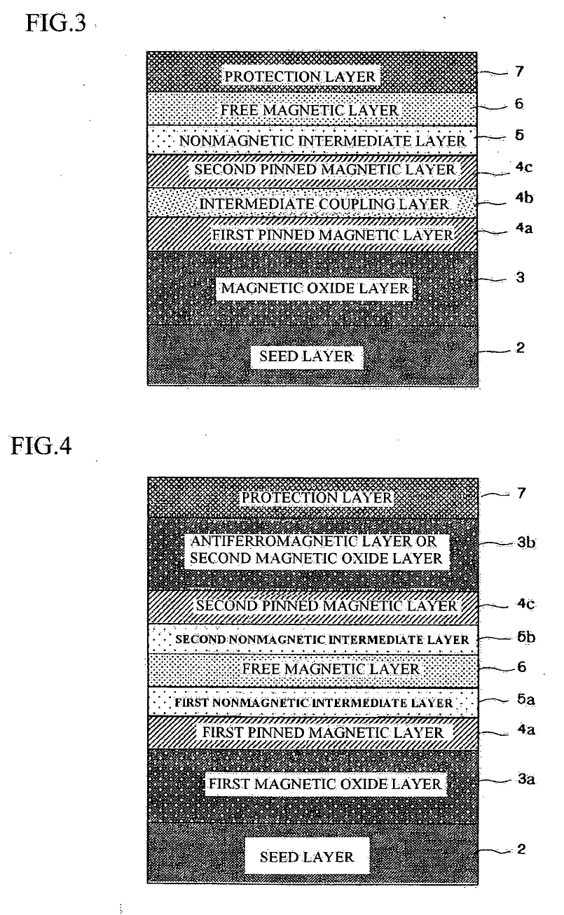

Modifications of the magnetoresistance effect film of the present invention are shown in FIGS. 3 and 4.

The magnetoresistance effect film shown in FIG. 1 has the one-layered pinned magnetic layer 4. On the other hand, in the embodiment shown in FIG. 3, the pinned magnetic layer has a three-layered structure constituted by a first pinned magnetic layer 4a, an intermediate coupling layer 4b and a second pinned magnetic layer 4c. This structure is called “layered ferri structure”. Ruthenium (Ru), iridium (Ir), rhodium (Rh), chromium (Cr), etc. are used for the intermediate coupling layer 4b. The first and second pinned magnetic layers 4a and 4c are antiferroinagnetically coupled by the intermediate coupling layer 4b. With this structure, the value of Hc(pin) can be increased, so that long term reliability of the magnetoresistance effect film can be improved.

In the embodiment shown in FIG. 4, a first magnetic oxide layer 3a, the first pinned magnetic layer 4a, a first nonmagnetic intermediate layer 5a, the free magnetic layer 6 are layered on the seed layer 2 made of the metallic oxide. Further, a second nonmagnetic intermediate layer 5b, the second pinned magnetic layer 4c and an antiferromagnetic layer (or a second magnetic oxide layer) 3b a are layered on the free magnetic layer 6 in this order.

Two magnetoresistance effect parts, each of which is constituted by the pinned magnetic layer, the nonmagnetic layer and the free magnetic layer so as to gain the magnetoresistance effect, are included in the film. This structure is called “dual structure”. By employing the dual structure, great MR ratio can be gained.

Platinum-manganese (PtMn), pradium-platinum-manganese (PdPtMn), iridium-manganese (IrMn), etc. are used for the antiferromagnetic layer 3b. Further, the second magnetic oxide layer made of, for example, the oxide including cobalt-ferrite may be formed, instead of the antiferromagnetic layer 3b, as the second magnetic oxide layer. Note that, the first pinned magnetic layer and the second pinned magnetic layer may have the layered ferri structure as well as the embodiment shown in FIG. 3.

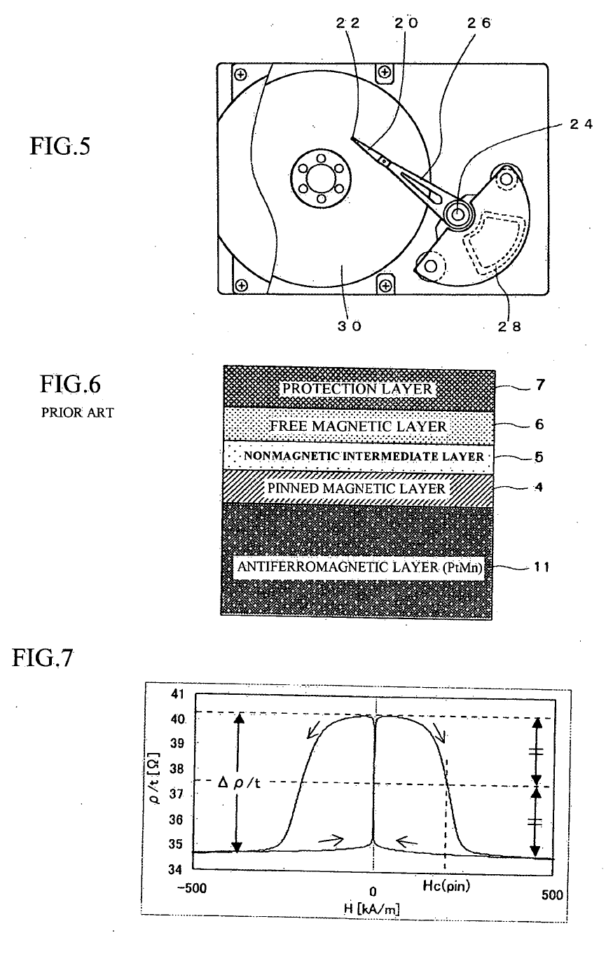

FIG. 5 is a plan view of a magnetic disk drive unit having a magnetoresistance effect head. The magnetoresistance effect head is assembled in a slider 22, which is attached to a front end of a head suspension 20 and whose air bearing surface faces on a surface of a magnetic disk 30. The head suspension 20 is supported at a front end of a head arm 26, which is rotatably supported by a shaft 24 and which is capable of swinging in parallel to the surface of the magnetic disk 30. When the magnetic disk 30 is rotated by a spindle motor (not shown), the slider 22 supported by the head suspension 20 is floated from the surface of the magnetic disk 30. Then, the head arm 26 is swung by a motor 28, so that recorded data are searched and reproduced by the magnetoresistance effect head.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetoresistance effect film having a layered structure, in which a seed layer, a magnetic oxide layer, a pinned magnetic layer, a nonmagnetic intermediate layer, and a free magnetic layer are layered in this order,
wherein said seed layer is made of a metallic oxide, and
said magnetic oxide layer is made of CoₓFe₃₋ₓO_{y} (x=1.10-1.71, y≠0).

2. The magnetoresistance effect film according to claim 1,
wherein said seed layer is made of a metallic oxide, in which at least one of lattice constant is within a range of 0.406-0.432 nm, or a solid solution of a plurality of metallic oxides having said lattice constant, or a solid solution of at least one of the metallic oxides and an oxide whose lattice constant is deviated from the range of 0.406-0.432 nm.

3. The magnetoresistance effect film according to claim 2,
wherein the metallic oxide is selected from a group including sodium dioxide (NaO₂), magnesium monoxide (MgO), potassium trioxide (KO₃), titanium monoxide (TiO), vanadium monoxide (VO), iron monoxide (FeO), cobalt monoxide (CoO), nickel monoxide (α-NiO), copper monoxide (Cu2O), rubidium dioxide (Rb₂O₂), niobium monoxide (NbO), cesium monoxide (Cs₂O) and cesium dioxide (Cs₂O₂).

4. The magnetoresistance effect film according to claim 1,
wherein said seed layer is made of a metallic oxide, in which at least one of lattice constant is within a range of 0.813-0.863 nm, or a solid solution of a plurality of metallic oxides having said lattice constant, or a solid solution of at least one of the metallic oxides and an oxide whose lattice constant is deviated from the range of 0.813-0.863 nm.

5. The magnetoresistance effect film according to claim 4,
wherein the metallic oxide is selected from a group including chromium trioxide (CrO₃), iron trioxide (γ-Fe₂O3) and iron tetroxide (Fe₃O₄).

6. The magnetoresistance effect film according to claim 1,
wherein said pinned magnetic layer includes a first pinned magnetic layer, an intermediate coupling layer, and a second pinned layer, and
wherein the first pinned magnetic layer and the second pinned magnetic layer are coupled in anti-parallel by an exchange coupling magnetic field.

7. The magnetoresistance effect film according to claim 2,
wherein said pinned magnetic layer includes a first pinned magnetic layer, an intermediate coupling layer, and a second pinned layer, and
wherein the first pinned magnetic layer and the second pinned magnetic layer are coupled in anti-parallel by an exchange coupling magnetic field.

8. The magnetoresistance effect film according to claim 3,
wherein said pinned magnetic layer includes a first pinned magnetic layer, an intermediate coupling layer, and a second pinned layer, and
wherein the first pinned magnetic layer and the second pinned magnetic layer are coupled in anti-parallel by an exchange coupling magnetic field.

9. The magnetoresistance effect film according to claim 4,
wherein said pinned magnetic layer includes a first pinned magnetic layer, an intermediate coupling layer, and a second pinned layer, and
wherein the first pinned magnetic layer and the second pinned magnetic layer are coupled in anti-parallel by an exchange coupling magnetic field.

10. The magnetoresistance effect film according to claim 5,
wherein said pinned magnetic layer includes a first pinned magnetic layer, an intermediate coupling layer, and a second pinned layer, and
wherein the first pinned magnetic layer and the second pinned magnetic layer are coupled in anti-parallel by an exchange coupling magnetic field.

11. The magnetoresistance effect film according to claim 6,
wherein said intermediate coupling layer is made of selected from a group including ruthenium (Ru), iridium (Ir), rhodium (Rh) and chromium (Cr), or an alloy including at least one selected from said group.

12. A magnetoresistance effect head including a magnetoresistance effect film, which has a layered structure, in which a seed layer, a magnetic oxide layer, a pinned magnetic layer, a nonmagnetic intermediate layer, and a free magnetic layer are layered in this order,
wherein said seed layer is made of a metallic oxide, and
said magnetic oxide layer is made of CoₓFe₃₋ₓO_{y} (x=1.10-1.71, y≠0).

13. The magnetoresistance effect head according to claim 12,
wherein said seed layer is made of a metallic oxide, in which at least one of lattice constant is within a range of 0.406-0.432 nm, or a solid solution of a plurality of metallic oxides having said lattice constant, or a solid solution of at least one of the metallic oxides and an oxide whose lattice constant is deviated from the range of 0.406-0.432 nm.

14. The magnetoresistance effect head according to claim 13,
wherein the metallic oxide is selected from a group including sodium dioxide (NaO₂), magnesium monoxide (MgO), potassium trioxide (KO₃), titanium monoxide (TiO), vanadium monoxide (VO), iron monoxide (FeO), cobalt monoxide (CoO), nickel monoxide (α-NiO), copper monoxide (Cu2O), rubidium dioxide (Rb₂O₂), niobium monoxide (NbO), cesium monoxide (Cs₂O) and cesium dioxide (Cs₂O₂).

15. The magnetoresistance effect head according to claim 12,
wherein said seed layer is made of a metallic oxide, in which at least one of lattice constant is within a range of 0.813-0.863 nm, or a solid solution of a plurality of metallic oxides having said lattice constant, or a solid solution of at least one of the metallic oxides and an oxide whose lattice constant is deviated from the range of 0.813-0.863 nm.

16. The magnetoresistance effect head according to claim 15,
wherein the metallic oxide is selected from a group including chromium trioxide (CrO₃), iron trioxide (γ-Fe₂O3) and iron tetroxide (Fe₃O₄).

17. The magnetoresistance effect head according to claim 12,
wherein said pinned magnetic layer includes a first pinned magnetic layer, an intermediate coupling layer, and a second pinned layer, and
wherein the first pinned magnetic layer and the second pinned magnetic 12yer are coupled in anti-parallel by an exchange coupling magnetic field.

18. The magnetoresistance effect head according to claim 17,
wherein said intermediate coupling layer is made of selected from a group including ruthenium (Ru), iridium (Ir), rhodium (Rh) and chromium (Cr), or an alloy including at least one selected from said group.

19. The magnetoresistance effect head according to claim 12,
wherein said seed layer is used as the whole or a part of an insulating gap layer.

20. The magnetoresistance effect head according to claim 19,
wherein the metallic oxide of said seed layer is nonmagnetic at temperature of 300° K.
